(19) United States
(12) Patent Application Publication
(10) Pub. No.: US 2011/0085767 A1
(43) Pub. Date: Apr. 14, 2011

(54) Cooled Laser Module

(75) Inventor: Rongsheng Miao, El Monte, CA (US)

(73) Assignee: Emcore Corporation, Albuquerque, NM (US)

(21) Appl. No.: 12/577,037

(22) Filed: Oct. 9, 2009

(51) Int. Cl. G02B 6/42; H01S 3/04; G02B 6/36

(52) U.S. Cl. 385/93; 372/34; 385/88

(57) ABSTRACT

An optoelectronic device includes a header having a plurality of pins extending therethrough, a thermo-electric cooling device mounted adjacent to a side of the header and an optoelectronic assembly mounted on the thermo-electric cooling device. The optoelectronic assembly includes a light emitting device operable to emit an optical signal in response to an electric signal received by at least one of the plurality of pins, and a lens assembly operable to receive at least some of the light emitted by the light emitting device, the lens assembly having a lens. A cap substantially encloses the thermo-electric cooling device and the optoelectronic assembly. The cap has a window operable to transmit light emitted by the optoelectronic assembly. The lens is the only optical component in the lens assembly.

### FIELD OF THE INVENTION

The invention relates to optoelectronic converters, and more particularly to integrated laser assemblies or modules that provide a communications interface between a computer or communications unit having an electrical connector or interface and an optical fiber, such as used in fiber optic communications links.

### BACKGROUND OF THE INVENTION

A variety of optoelectronic transceivers are known in the art. Such devices typically include an optical transmitter portion (that converts an electrical signal into a modulated light beam that is coupled to an optical fiber), and a receiver portion (that receives an optical signal from an optical fiber and converts it into an electrical signal). Traditionally, optical receiver sections include an optical assembly to focus or direct the light from the optical fiber onto a photodetector, which in turn, is connected to an amplifier/limiter circuit on a circuit board. The photodetector or photodiode is typically packaged in a hermetically sealed package in order to protect it from harsh environmental conditions.

Coaxial laser modules have seen some use in fiber optic telecommunication and CATV applications. Such modules typically use transistor outline (TO) packages and provide a relatively low cost solution in some markets. However, for applications where the laser consumes a relatively large amount of power or the laser is operated over a wide range of ambient temperatures, the laser diode (LD) and other optical components must be cooled in order to meet the requirements of an extremely narrow frequency spectrum and stable LD performance. External, forced air cooling has been the method of choice.

The use of internal cooling with TO packages has proven difficult due to the limited space within the TO header and the size of the active and passive components found therein. One previous effort in this regard involved the cooling of a converter module using very small custom thermo-electric coolers (TECs) and was limited to the cooling of only the active components (i.e., the LD) and not the passive components (i.e., lens and isolator). The cooling of only the active components has been found to result in unstable optical performance where a wide range of operating temperatures is involved.

U.S. Pat. No. 7,118,292 discusses a TO package housing a laser diode, a monitor photodiode (MPD) and a lens-isolator combo which are all mounted in thermal contact with a thermo-electric cooler. The use of a lens-isolator combo raises the thermal load, and also the cost due to the requirement of a relatively large clear aperture. In the TO package discussed in U.S. Pat. No. 7,118,292, light is directed from the rear facet of the LD to the MPD via a mirror mounted on a wedge. This has the advantage of lowering the profile of the components mounted on the cold plate, improving mechanical and thermal stability. But the addition of the mirror and the wedge also increases cost.

### SUMMARY OF THE INVENTION

It is an object of the present invention to provide an improved optical transmitter using an integrated thermal electric cooler and other optical subassemblies.

This and other objects are provided by an optoelectronic device comprising a header having a plurality of pins extending therethrough, a thermo-electric cooler mounted adjacent to the second side of the header, an optoelectronic assembly mounted on the thermo-electric cooler, and a cap substantially enclosing the thermo-electric cooler and the optoelectronic assembly, the cap having a window operable to transmit light emitted by the optoelectronic assembly. The optoelectronic assembly includes a light emitting device operable to emit an optical signal in response to an electric signal received by at least one of the plurality of pins, and a lens assembly operable to receive at least some of the light emitted by the light emitting device. A lens is the only optical component in the lens ring assembly, so that the thermal load on the thermo-electric cooler is relatively small and the cost of the optoelectronic device is reduced.

This and other objects are also provided by an optoelectronic device comprising a header having a plurality of pins extending therethrough, a light emitting device operable to emit an optical signal in response to an electric signal received by at least one of the plurality of pins, said light emitting device being operable to emit light from two opposing sides, a light detector, and a cap substantially enclosing the light emitting device and the light detector, the cap having a window operable to transmit light emitted from one of said two opposing sides of the light emitting device. Light emitted from the other of said two opposing sides of the light emitting device is emitted along a light path directly to the light detector, and the light detector is positioned perpendicular to a central axis of the light path for light emitted from said other of said two opposing sides away from said central axis of the light path. Alternatively, the light detector may be positioned oblique to the central axis of the light path.

### BRIEF DESCRIPTION OF THE DRAWINGS

FIG. 1 is a perspective view of the proposed coaxial cooled laser module.

FIG. 2 (a) and (b) are typical views of the TO-can package and the cap of FIG. 1 with a flat window;

FIG. 3 shows the TO header of FIG. 1 and its pin orientation;

FIG. 4 shows the configuration of a laser diode and a monitor photodiode forming part of the module of FIG. 1;

FIG. 5 shows a side view of the laser diode and monitor photodiode configuration illustrated in FIG. 4;

FIG. 6 shows a side view of an alternative laser diode and monitor photodiode configuration;

FIG. 7 shows an optical lens assembly forming part of the module of FIG. 1;

FIG. 8 shows an optoelectronic assembly including the laser diode and monitor photodiode configuration of FIGS. 4 and 5 and the lens assembly of FIG. 7;

FIG. 9 shows an alternative optical lens assembly; and

FIG. 10 shows an alternative optoelectronic assembly including the laser diode and monitor photodiode configuration of FIG. 6 and the lens assembly of FIG. 8.

It should be noted that the dimensions and scales shown in above figures are not accurate and are for illustration and explanation only. Similarly, the components shown in the figures also are for illustration and explanation purpose. Actual components may vary. For simplicity, the wirebonds between the components are omitted herein.

### DETAILED DESCRIPTION OF THE PREFERRED EMBODIMENT

Details of present invention will now be described, including exemplary aspects and embodiments thereof.

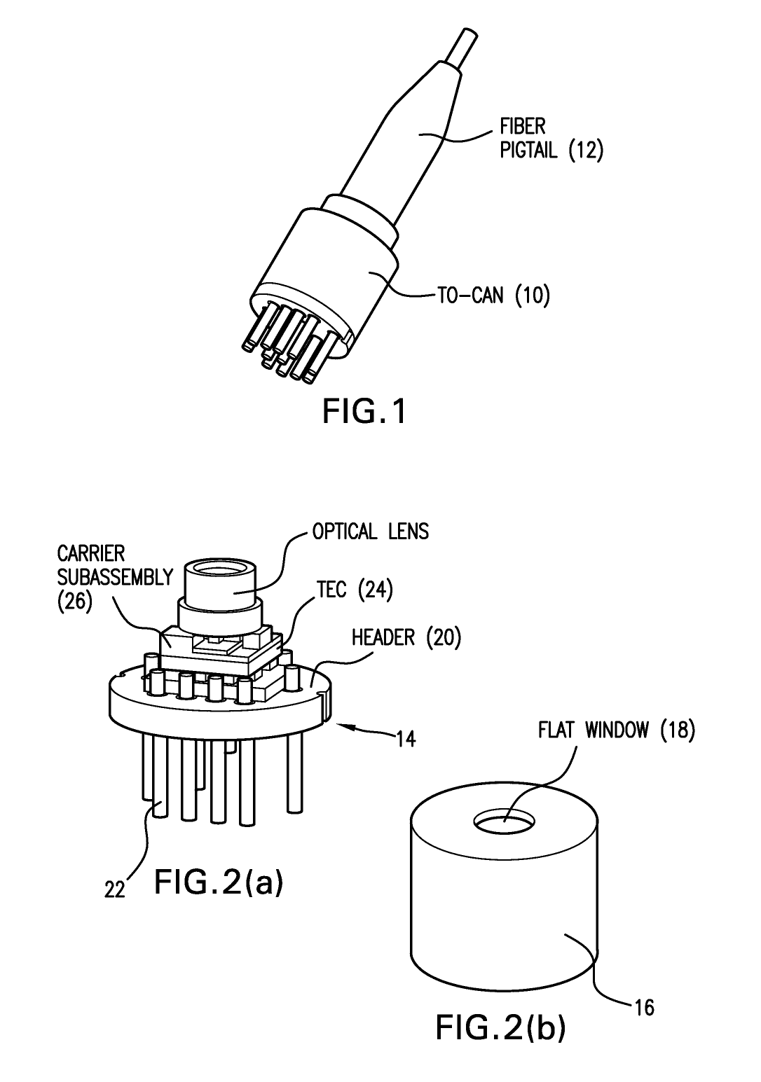

With this in mind, FIG. 1 shows a coaxially cooled laser module having a TO-can 10 and a fiber pigtail module 12, having a proximal end and a distal end, which functions to align an axis of light transmission between the TO-can 10 and an optical fiber.

The TO-can 10 consists of a TO header subassembly 14, as shown in FIG. 2(a), and a sealing cap 16 with a flat window 18, as shown in FIG. 2(b). In this embodiment, the flat window 18 has a few degrees of tilt from the axis of the laser beam to reduce back reflection, although this is not essential.

As shown in FIG. 2(a), the TO header subassembly 14 includes a TO header 20 with a number of electrical conductor pins 22 extending through the TO header 20. The TO header subassembly 14 also includes a thermo-electric cooler (TEC) 24 and an optoelectronic assembly 26 that supports active and passive optical components including a laser diode (LD), a monitor photodiode (MPD), and an optical lens assembly. The TO header 20 may be made of a number of different materials, like cold roll steel, Kovar or other alloys. The diameter of the header should be large enough to accommodate a selected TEC 24. In this embodiment, the TO header 24 is 9 mm in diameter.

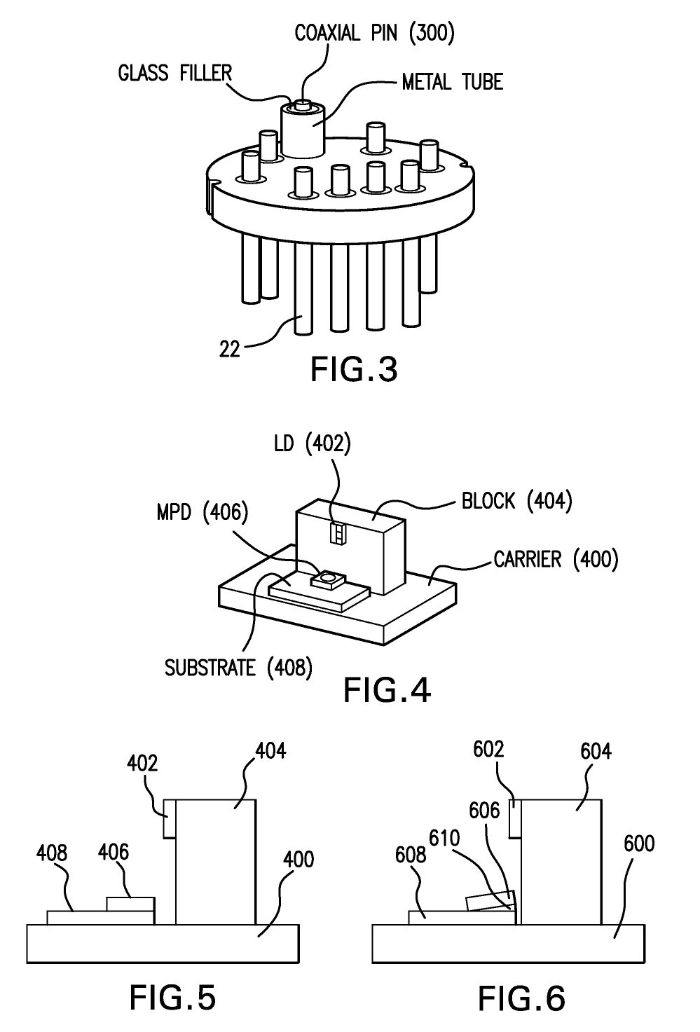

In this embodiment, the header pins 22 are in an inline layout as shown in FIG. 3. Alternatively, the header pins 22 may be in a circular arrangement. In order to get better RF performance at high frequency ranges, an RF pin 300 is designed to have good impedance match. In this embodiment, the RF pin 300 is a coaxial pin consists of metal tubing and a glass filler. The diameters of the tubing and pin are determined by the matching impedance and dielectric constant of the glass filler. The metal tubing is brazed on the header.

The TEC 24 may be any commercial available miniature cooler that consists of a hot plate, a cold plate and thermal electric semiconductor elements. The thermal electric semiconductor elements are placed in couples. The thermal capacity of the TEC 24 should be chosen so that it has a sufficient number of thermal couples to dissipate both the active heat load generated by LD and the passive heat load leaked into the package from the surrounding environment, while still keeping the cost low. In this embodiment, the TEC 24 has a footprint of approximately 5×4 mm.

As discussed in U.S. Pat. No. 7,118,292, the whole contents of which are hereby incorporated herein by reference, two wirebond pads are located in opposite ends of the TEC 24. Other configurations of the wirebond pads are possible. In this embodiment, the TEC 24 is soldered to the center of the TO header 20 with the hot plate adjacent to the TO Header 20, and the wirebond pads are connected to pins 22 via a pair of wirebonds.

The optoelectronic assembly 26 has a carrier 400 which is mounted onto the cold plate of the TEC 24. In this embodiment, the carrier 400 is made of Kovar, but alternatively it could be made of stainless steel or any other suitable material with good thermal conductivity. As shown in FIG. 4, in this embodiment the LD 402 is mounted on a LD submount 404, which is in turn mounted on the carrier 400. The LD submount 404 is made of aluminum nitride (AIN), although a different material with good thermal conductivity could alternatively be used. In this embodiment, the LD 402 is an edge emitting laser and is soldered vertically on the submount. The edge emitting LD 402 emits laser light in two directions, one is in a forward direction from a front facet and the other is backward from a rear facet.

Alternatively, a surface emitting laser is also suitable for this application with slight modification of the LD submount 404.

In a traditional uncooled TO laser package where the edge-emitting laser is used, an MPD is mounted directly beneath the LD to catch the laser light from the rear facet of the LD for purposes of monitoring laser performance. This configuration has a drawback in that it results in back reflection into the laser diode. As shown in FIG. 5, in this embodiment the MPD 406 is mounted on a substrate (408) which is not directly beneath the LD 402, so that the MPD 406 is offset from being directly beneath the LD 402 in order to reduce back reflection into the LD 402. In particular, the LD 402 emits laser light along a light path having a central axis. The MPD 406 is positioned perpendicular to the central axis of the light path at a position away from the central axis so that light travelling along the central axis does not impinge on the MPD 406, but rather a portion of the light away from the central axis is incident on the MPD 406.

FIG. 6 shows an alternative configuration in which a MPD 606 is positioned directly beneath the rear facet of an LD 602, but is mounted on a wedge 610 to reduce back reflection into the LD 602.

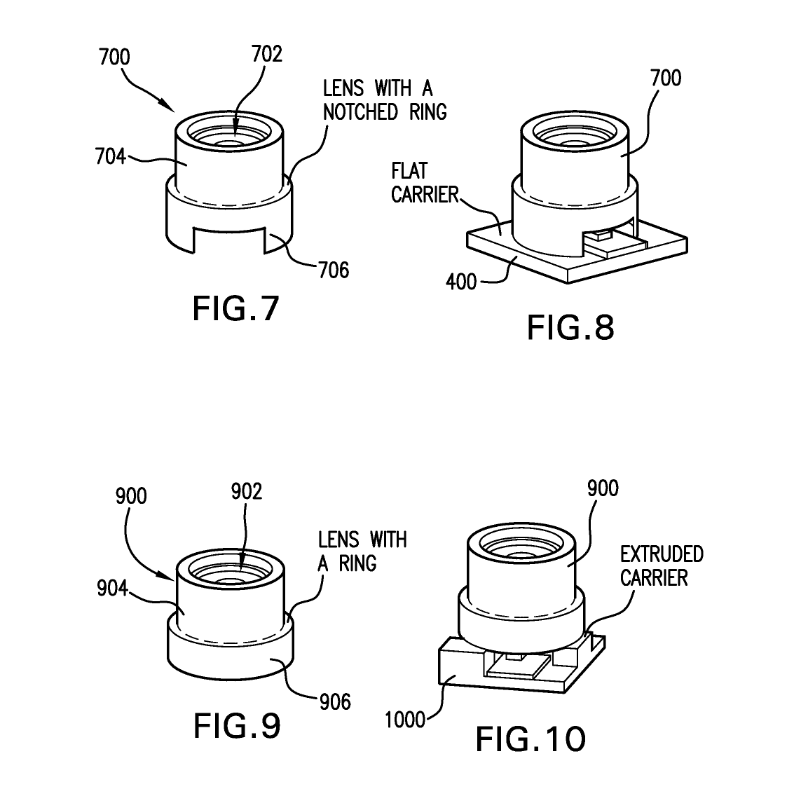

FIG. 7 shows a lens assembly 700 which is also mounted on the carrier 400, as shown in FIG. 8. The lens assembly 700 consists of an optical lens 702 which is bonded into a metal housing 704. The optical lens 702 is the only optical component in the lens assembly 700. In this embodiment, the optical lens 702 is an aspheric lens having a numerical aperture (NA) of 0.4. Other values of NA could be used, and a ball lens could alternatively be used. The surface of the lens may have an anti-reflective (AR) coating. The metal housing 704 includes at one longitudinal end a metal ring portion 706 having notches. As shown in FIG. 8, the lens assembly 700 is mounted to the carrier 400 with the notched ring portion 706 adjacent the carrier 400.

The optical lens 702 may be pre-fixed to the metal housing 704 prior to assembly. Alternatively, the optical lens 702 may be slip-fit within the metal housing 704 to allow the position of the optical lens 702 to be adjustable during an alignment process. The optical lens 702 can be bonded to the metal housing 704 in various ways, for example using either epoxy or laser welding. Similarly, the lens assembly can be bonded to the carrier 400 in various ways, for example using either epoxy or laser welding.

The placement of the lens assembly 700 onto the carrier 400 can be done using either active or passive alignment. In particular, by using an optical lens 702 with a relatively low NA, there is less sensitivity to lens placement allowing passive alignment to be used, and in addition the working distance from the laser to the lens is longer, allowing more room for component placement.

In an alternative embodiment, as shown in FIG. 9 the lens assembly 900 consists of an optical lens 902 which is bonded into a metal housing 904 having a metal ring portion 906 without notches at one longitudinal end. In this alternative embodiment, as shown in FIG. 10, the carrier 1000 has extruded portions and the lens assembly 900 is mounted on the extruded portions.

By mounting the lens assembly on the carrier, this coaxial package provides cooling for both active components (i.e. the LD and the MPD) and passive components (i.e. the optical lens) on the cooled platform, ensuring stable performance over a wide range of operation temperature.

As discussed above, the only optical component in the lens assembly is the optical lens, so that the optical lens is the only optical component in the light path between the LD and the window of the cap. The lens assembly does not include an optical isolator. In an embodiment, an optical isolator is mounted at the proximal end of the fiber pigtail module 12. Alternatively, an inline optical isolator may be used.

Compared with a traditional butterfly package, the coaxial package described herein consumes much less DC power than the butterfly package, for substantially the same laser output. Typically only half of the DC consumed by the butterfly package is needed by the module described above. Therefore, the package reliability is increased and thermal efficiency is also increased.

The coaxial package simplifies the manufacturing processes and significantly reduces component and labor cost compared with the coaxial package discussed in U.S. Pat. No. 7,118,292.

It will be understood that elements described above, or two or more together, may be replaced by functionally equivalent elements which satisfy the design requirements. For example, the photodiode could be replaced by an alternative photodetector.

1. An optoelectronic device comprising:
a header having a plurality of pins extending therethrough;
a thermo-electric cooling device mounted adjacent to a side of the header;
an optoelectronic assembly mounted on the thermo-electric cooling device, the optoelectronic assembly comprising:
a light emitting device operable to emit an optical signal in response to an electric signal received by at least one of the plurality of pins, and
a lens assembly operable to receive at least some of the light emitted by the light emitting device, the lens assembly having a lens;
and a cap substantially enclosing the thermo-electric cooling device and the optoelectronic assembly, the cap having a window operable to transmit light emitted by the optoelectronic assembly,
wherein the lens is the only optical component in the lens assembly.

2. An optoelectronic device according to claim 1, wherein the window is angled obliquely to the light path.

3. An optoelectronic device according to claim 1, wherein the plurality of pins comprises a coaxial pin having a center pin and a metal sleeve separated by a dielectric material.

4. An optoelectronic device according to claim 3, wherein the dielectric material is a glass.

5. An optoelectronic device according to claim 1, wherein the lens assembly comprises:
a lens housing in which the lens is mounted; and
a supporting ring supporting the lens housing.

6. An optoelectronic assembly according to claim 5, wherein the supporting ring has notches and is mounted on a flat carrier.

7. An optoelectronic assembly according to claim 5, wherein the supporting ring has notches and is mounted on an extruded carrier.

8. An optoelectronic device as claimed in claim 1, further comprising an optical fibre pigtail having a proximal end and a distal end, the proximal end being coupled to the cap such that light transmitted through the window of the cap is directed into the optical fibre.

9. An optoelectronic device as claimed in claim 8, wherein an optical isolator is mounted at the proximal end of the optical fibre pigtail.

10. An optoelectronic device comprising:
a header having a plurality of pins extending therethrough;
a light emitting device operable to emit an optical signal in response to an electric signal received by at least one of the plurality of pins, said light emitting device being operable to emit light from two opposing sides;
a light detector; and
a cap substantially enclosing the light emitting device and the light detector, the cap having a window operable to transmit light emitted from one of said two opposing sides of the light emitting device,
wherein light emitted from the other of said two opposing sides of the light emitting device is emitted along a light path directly to the light detector, and
wherein the light detector is positioned perpendicular to a central axis of the light path for light emitted from said other of said two opposing sides away from said central axis of the light path.

11. An optoelectronic device according to claim 10, further comprising a thermo-electric cooling device, wherein the light emitting device and the light detector form part of an optoelectronic assembly mounted on the thermo-electric cooling device.

12. An optoelectronic device comprising:
a header having a plurality of pins extending therethrough;
a light emitting device operable to emit an optical signal in response to an electric signal received by at least one of the plurality of pins, said light emitting device being operable to emit light from two opposing sides;
a light detector; and
a cap substantially enclosing the light emitting device and the light detector, the cap having a window operable to transmit light emitted from one of said two opposing sides of the light emitting device,
wherein light emitted from the other of said two opposing sides of the light emitting device is directed along a light path directly to the light detector, and
wherein the light detector is positioned oblique to a central axis of the light path.

13. An optoelectronic device according to claim 12, wherein the light detector is mounted on a wedge.

14. An optoelectronic device according to claim 12, further comprising a thermo-electric cooling device, wherein the light emitting device and the light detector form part of an optoelectronic assembly mounted on the thermo-electric cooling device.

15. An optoelectronic device comprising:
a header having a plurality of pins extending therethrough;
a light emitting device mounted on the header, the light emitting device operable to emit an optical signal in response to an electric signal received by at least one of the plurality of pins;
a lens operable to receive at least some of the light emitted by the light emitting device;
a thermo-electric cooling device mounted adjacent to a side of the header; and
a cap substantially enclosing the thermo-electric device, the light emitting device and the lens, the cap having a window operable to transmit light emitted by the light emitting device which has passed though the lens,
wherein the lens is the only optical component in said light path between the light emitting device and the window.
